(19) United States
(12) Patent Application Publication
(10) Pub. No.: US 2006/0132620 A1
(43) Pub. Date: Jun. 22, 2006

(54) DATA RECORDING APPARATUS AND METHOD THEREOF

(75) Inventors: Shinichi TAKADA, Takatsuki-shi, Osaka (JP); Michiko SHIGEMORI, Itami-shi, Hyogo (JP)

Correspondence Address: GREENBLUM & BERNSTEIN, P.L.C., 1950 ROLAND CLARKE PLACE, RESTON, VA, 20191, US

(73) Assignee: Matshushita Electric Industrial Co., Ltd., Osaka (JP)

(21) Appl. No.: 11/275,143

(22) Filed: Dec. 15, 2005

(30) Foreign Application Priority Data
Dec. 17, 2004 (JP) 2004365721
Nov. 15, 2005 (JP) 2005330688

(51) Int. Cl. H04N 5/76

(52) U.S. Cl. 348/231.3; 348/231.99

(57) ABSTRACT

An image file recording apparatus of the present invention records, into a recording medium, an image file that includes image data and header information which has variable-length information, and includes: a JPEG compression unit which generates image data; a microcomputer which determines a first address indicating the head of the image file and a second address obtained by adding a fixed value to the first address; and an APP portion writing unit 205 which writes, without going through a memory, the image data into an area, in the recording medium, starting from the second address.

### BACKGROUND OF THE INVENTION

(1) Field of the Invention

The present invention relates to an image file storing apparatus which records, into a recording medium, an image file including image data header information that has variable-length information.

(2) Description of the Related Art

For recording, into an external memory, an image shot by a digital camera, a file based on an Exchangeable image file format (Exif) standard (hereinafter to be referred to as “Exif file”) is created.

As shown in FIG. 1, an Exif file sequentially includes from the head: an application/marker segment 1 (hereinafter to be referred to as “APP1”) in which image data appendix information to be required for a compressed data start marker indicating a start of compressed data file; compressed original image data obtained by compressing an original image in compliance with a JPEG standard; and a compressed data end marker indicating an end of the compressed data file. Note that the compressed original image data includes original image compression condition data describing the conditions, such as a quantization table and a Huffman table, used for the compression of the original image data based on the JPEG standard.

The APP1 is made up of: an APP1 header (including an APP1 marker, APP1 Length, an Exif identification code and a TIFF header) describing a data size of APP1; 0thIFD (0th Image File Directory) describing information about an original image; ExifIFD describing information unique to the Exif; a compatibility IFD describing information for assuring compatibility; 1thIFD descriing information about a thumbnail image; and compressed thumbnail image data obtained by compressing a thumbnail image based on the JPEG. It should be noted that the compressed thumbnail image data includes thumbnail image compression condition data describing the conditions, such as a quantization table and a Huffman table, used for the compression of the thumbnail image data based on the JPEG.

Thus, an order of the data included in each Exif file is defined in the Exif standard, so that it is required to create thumbnail image data based on original image data and perform JPEG compression onto both of the data for recording an image into an external memory.

An example of efficient creation of a thumbnail image with an attempt to create an Exif file with high-speed is disclosed in the Japanese Laid-Open Application No. 2002-218373.

FIG. 2 shows a sequence of processing related to the conventional storage of image data. As described above, a thumbnail image and an original image are both necessary for the creation of an Exif file, and jPEG compression shall be performed at least two times (Steps c2 and c5). The JPEG defines an image size of a thumbnail image to be 160×120 pixels, therefore, an original image needs to be reduced for the creation of a thumbnail image (Step c3). This is why compressed data of a thumbnail image is normally created after the creation of compressed original image data (Step c5).

### SUMMARY OF THE INVENTION

As shown in FIG. 1, however, compressed thumbnail image data is located prior to compressed original image data in an Exif file so that the compressed original image data cannot be recorded immediately after the creation of the compressed original image data.

Since an item indicating a data size of APP1 is included in the APP1 header, it is possible to know the size of the compressed thumbnail image data only after the compression of the thumbnail image data, which renders it impossible to create an APP1 header.

Presently, after JPEG compression is performed onto both the thumbnail image and the original image so as to create compressed data for the respective data, the respective compressed image data are once stored in a main memory (Steps c4 and c6), the data is re-ordered in an order specified in the Exif file (Step c7), and then, an image is stored into an external memory (Step c8).

Consequently, the compression of an original image data which occupies the most part of the Exif file and the storage of the compressed original image data into an external memory cannot be performed in parallel with each other, which makes shooting intervals long.

The present invention is conceived in view of the above problem, and an object of the present invention is to provide an image file recording apparatus which efficiently records image data into an external memory and shortens the time required for completely storing the image data after the shooting of an image, so as to shorten the shooting intervals.

In order to achieve the above problem, the image file recording apparatus of the present invention records, into a recording medium, an image file including image data and header information which has variable-length information, and includes: a generation unit which generates image data; a determination unit which determines a first address indicating a head of the image file, and a second address obtained by adding a fixed value to the first address; and a writing unit which writes, without going through a memory, the image data into an area, in the recording medium, starting from the second address.

With the above structure, the determination unit can determine the second address although the creation of the header information is not completed. As a result, it is possible to start the storage of image data before the creation of the header information is completed. Also, the image data is written into an external memory without going through a memory so that it is possible to shorten the time required to complete the storage of the image file after the start of the creation of the image data. Thus, it is possible to shorten the storage intervals in the case where the creation of image data and the storage of the image data into a memory are sequentially performed.

The determination unit may determine, as the first address, a head address of a free space in the recording medium.

The writing unit may write the image data into the recording medium in parallel with the generation of image data performed by the generation unit.

With the above structure, it is possible to further shorten sequential storage intervals since the creation of the image data and the writing of the image data into the memory are performed in parallel.

After generating the image data, the generation unit may further generate thumbnail image data of the image data, and the writing unit may further record header information including the thumbnail image data into an area between the first address and the second address in the recording medium.

With the structure as described above, the size of an area for storing the header information which includes thumbnail image data is fixed. It is therefore possible to store image data without waiting for the completion of the storage of the header information.

The writing unit may write the thumbnail image data into the recording medium in parallel with the generation of thumbnail image data performed by the generation unit.

According to the above structure, creation of thumbnail image data and writing of the thumbnail image data into the memory are performed in parallel. It is therefore possible to further shorten the sequential storage intervals.

The image file recording apparatus may further include a detection unit which detects an end-of-image code indicating an end of the image data generated by the generation unit, wherein the writing unit may start recording the header information when an end-of-image code is detected by the detection unit.

With such structure, the writing unit can start storing the header information immediately after the completion of the storage of the image data. It is therefore possible to further shorten the sequential storage intervals.

The image file recording apparatus may further include a creation unit which creates header information which excludes thumbnail information related to the thumbnail image data, before the thumbnail image data is generated by the generation unit, and to record the created header information into the recording medium, wherein the writing unit is operable to obtain, from the generation unit, the thumbnail information before the thumbnail image data is generated by the generation unit, and to write, as the header information, the created header information stored in the memory and the obtained thumbnail information into the recording medium.

With the structure as described above, the writing unit can effectively store the thumbnail information included in the header information and other information aside from the thumbnail information. It is therefore possible to further shorten the sequential storage intervals.

The image file recording apparatus may further include a conversion unit which converts, into a text, a time signal outputted from a timer circuit, wherein said creation unit is operable to obtain, from the conversion unit, the text as a part of the header information.

According to such structure, a time signal is not converted into a text via software, therefore, it is possible to speed-up the creation of the header information.

An image file recording method according to the present invention includes, as steps, the operation carried out by the image file recording apparatus as described above, and a camera using the method includes the same units as incorporated in the image file recording apparatus. The detailed description will be abbreviated here.

According to the present invention, it is possible to shorten the time required of the completion of image file recording after the start of the generation of image data. As a result, it is possible to shorten recording intervals in the case where the generation of image data and the recording into a recording medium are sequentially operated.

### FURTHER INFORMATION ABOUT TECHNICAL BACKGROUND TO THIS APPLICATION

The disclosure of Japanese Patent Application No. 2004-365721 filed on Dec. 17, 2004 and No. 2005-330688 filed on Nov. 15, 2005, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a structure of an Exif file;

FIG. 2 is a diagram showing conventional processing timing;

FIG. 3 is a diagram showing a structure of a typical digital camera;

FIG. 4 shows an example of a structure of a data recording apparatus according to an embodiment of the present invention;

FIG. 5A shows a processing timing according to the embodiment;

FIG. 5B shows a processing timing according to the embodiment;

FIG. 6 is a flowchart showing a flow of image storing operation;

FIG. 7 is a diagram showing a state of a main memory before shooting of images;

FIG. 8 shows the operation inside an external memory in stage F2;

FIG. 9 is a diagram showing a structure of IFD;

FIG. 10 is a chart showing a timing to change a size of compressed thumbnail image data;

FIG. 11 is a diagram showing a state of the main memory before shooting of images, in the case where a size of an ExifIFD changes; and

FIG. 12 shows the operation inside the external memory, in the case where the processing shown in FIG. 5B is performed.

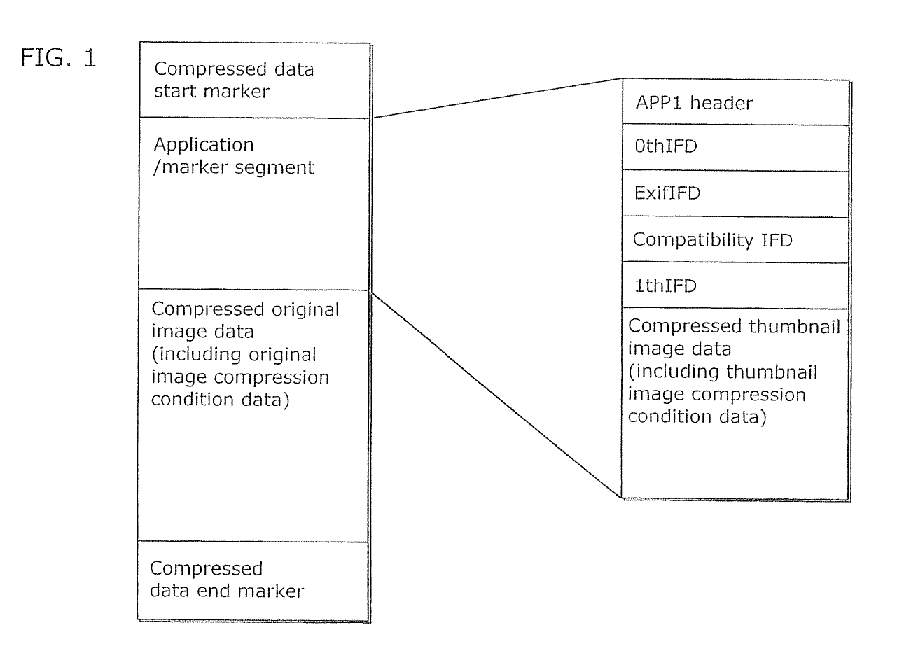

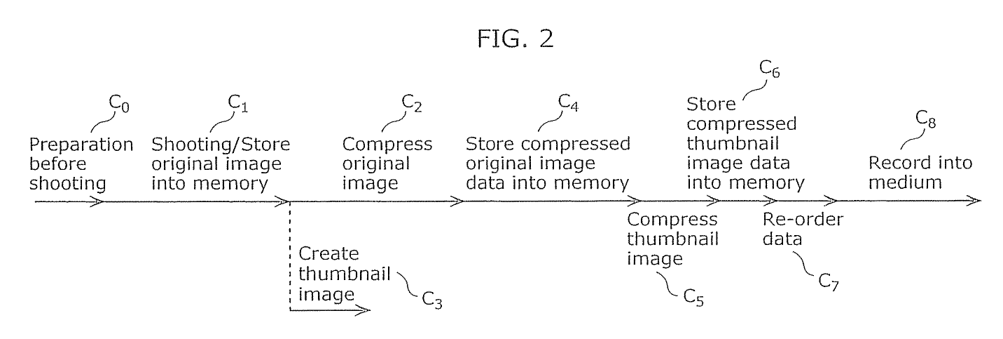

### DESCRIPTION OF THE PREFERRED EMBODIMENT(S)

The following describes the present invention with reference to the diagrams.

### Embodiment

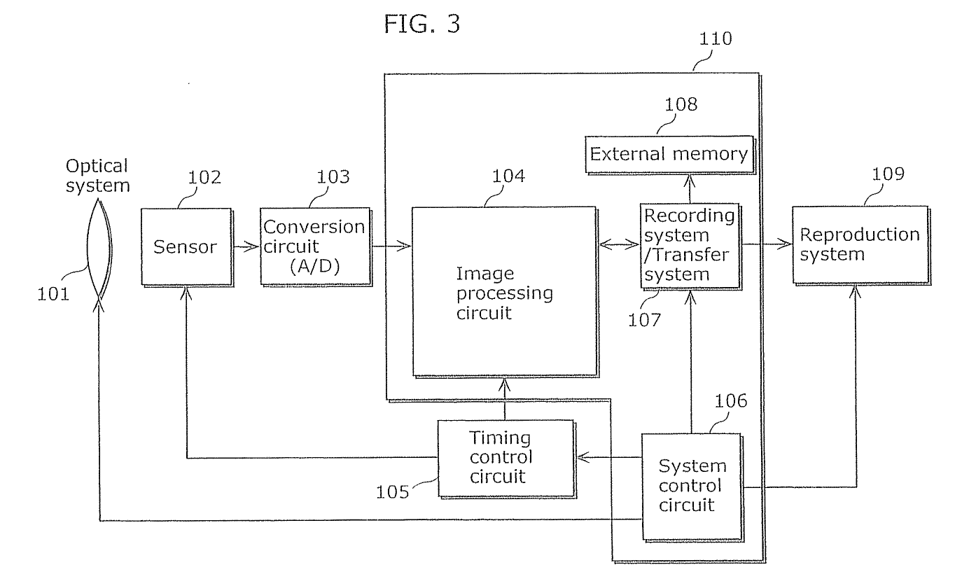

FIG. 3 is a block diagram showing a structure of a typical digital camera. As shown in the diagram, the digital camera includes an optical system 101, a sensor 102, a conversion circuit 103, a timing control circuit 105, a reproduction system 109, and a data recording apparatus 110. The data recording apparatus 110 includes an image processing circuit 104, a system control unit 106, a recording system/transfer system 107 and an external memory 108.

Light collected by the optical system 101 is recognized as image data by the sensor 102. The image processing circuit 104 performs JPEG compression to the digitalized image data and the recording system/transfer system 107 stores the compressed image data into the external memory 108. The reproduction system 109 displays image data and the timing control circuit 105 controls the sensor 102. The structure of the data recording apparatus 110, as shown in FIG. 3, including the image processing circuit 104, the recording system/transfer system 107, the system control circuit 106 and the external memory 108, is the structure used in the embodiment.

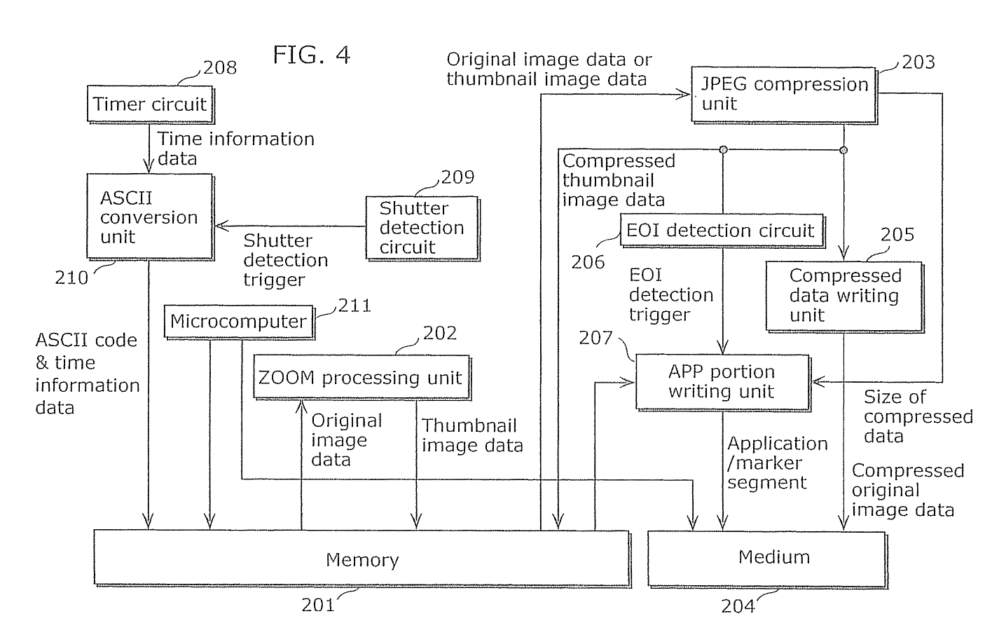

FIG. 4 is a block diagram showing an example of the structure of the data recording apparatus 110 shown in FIG. 3, according to the embodiment of the present invention. The data recording apparatus 110 includes, as shown in FIG. 4, a memory 201, a ZOOM processing unit 202, a JPEG compression unit 203, a medium 204, a compressed data writing unit 205, an EOI detection circuit 206, an APP portion writing unit 207, a timer circuit 208, a shutter detection circuit 209, an ASCII conversion unit 210, and a microcomputer 211. Note that, in the embodiment, the medium 204 is an external memory and the memory 210 is a main memory.

The memory 201 stores an APP1 describing image data (original image data and thumbnail image data) and image data appendix information. The ZOOM processing unit 202 reads out original image data, reduces the size of the original image data to the size of a thumbnail image (160×120 pixels) so as to create a thumbnail image, and writes the thumbnail image data into the memory 201. The JPEG compression unit 203 reads out image data from the memory 201, performs JPEG compression to the image data, and outputs the compressed image data and its size. The medium 204 stores the image data as an Exif file. The compressed data writing unit 205 writes, into the medium 204, the compressed original image data outputted from the JPEG compressing unit 203. The EOI detection circuit 206 detects an EOI marker of the compressed thumbnail image data outputted from the JPEG compression unit 203, and outputs an EOI detection trigger. The APP portion write processing unit 207 is activated by the EOI detection trigger outputted by the EOI detection circuit 206, reads out the APP1 from the memory 201, and writes it into the medium 204. In the case where 1thIFD data is being read out, the APP portion writing unit 207 replaces, with the proper size, the size of compressed thumbnail image data that is arbitrarily set. The timer circuit 208 reads time based on time information described in the APP1. The shutter detection circuit 209 detects the time when the user pressed a shutter, and outputs a shutter detection trigger. The ASCII conversion unit 210 reads the time information data from the timer circuit 208 based on the shutter detection trigger, converts the time information into ASCII codes (i.e. text) in compliance with the Exif standard, and writes the codes into the part assigned for the time information in the APP1 stored in the memory 201. Each time an image is shot, the microcomputer 211 assigns an area to be rewritten in the memory 201 and the medium 204, and rewrites the information that needs to be rewritten in the APP1.

In FIG. 3, the external memory 108 corresponds to the medium 204, the recording system/transfer system 107 corresponds to the data writing unit 205 and the APP portion writing unit 207, the system control circuit 106 corresponds to the microcomputer 211, and the image processing circuit 104 corresponds to other components in FIG. 3, that is, the memory 201, the ZOOM processing unit 202, the JPEG compression unit 203, the EOI detection circuit 206, the timer circuit 208, the shutter detection circuit 209, and the ASCII conversion unit 210.

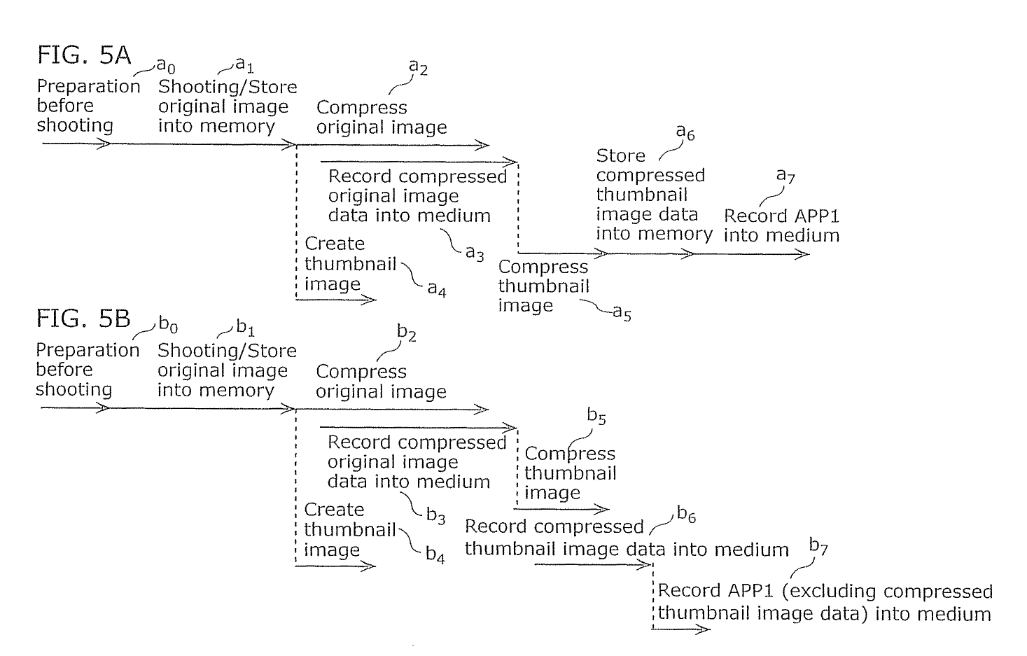

Next, the processing timing of the data recording apparatus 110 shown in FIG. 3 will be described with reference to FIG. 5A.

Firstly, the power is turned on as a preparation for shooting (Step a0), and after an image is shot, original image data is stored into the memory 201 (Step a1). A thumbnail is created (Step a4) in parallel with the processing of compressing an original image (Step a2). The compressed original image data is stored into the medium 204 (Step a3). When the storage of the compressed original image data into the medium 204 (Step a3) is terminated, a compression of the thumbnail image starts (Step a5). The compressed thumbnail image data is stored once into the memory 201 (Step a6), and the APP1 is stored into the medium 204 (Step a7). Note that the compressed thumbnail image data is included in the APP1, as described above.

The detail of such processing will be described using several stages.

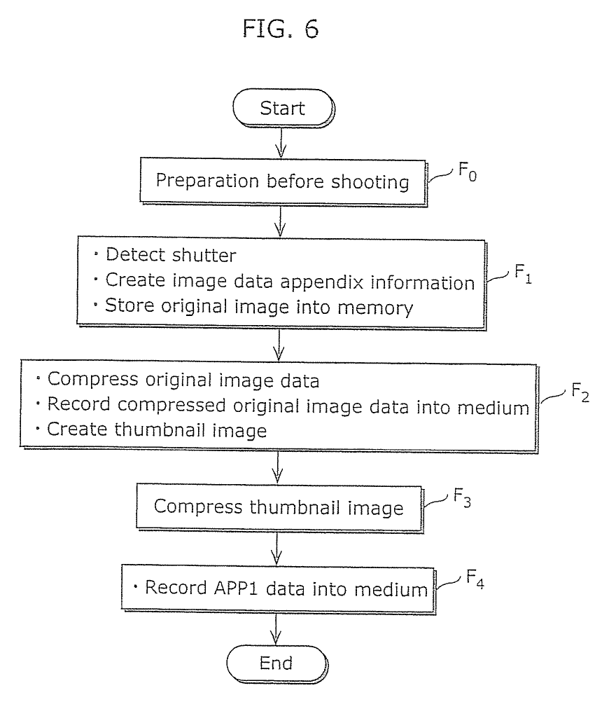

FIG. 6 is a diagram presenting, as stages F0 through F4, a sequence of processing starting from the shooting of images until the storage of the images into the medium 204. In the stage F0, a preparation is made before the shooting. In the stage F1, the following operations are performed: a shutter is detected; image data appendix information is created; and an original image is stored into the memory 201. In the stage F2, the original image data is compressed, the compressed original image data is stored into the medium 204, and a thumbnail image is created with respect to the original image data. In the stage F3, the thumbnail image is compressed. In the stage F4, the APP1 data is stored into the medium 204. Correspondence between each of the steps shown in FIG. 5A and each of the stages shown in FIG. 6 are as follows: the stage F0 and the step a0; the stage F1 and the step a1; the stage F2 and the step a2, a3 and a4; the stage F3 and the steps a5 and a6; and the stage F4 and the step a7.

The following describes the stage F0. In the stage F0, before shooting, a storage area is assigned for APP1 in the memory, and a template is prepared for each data in the APP1, aside from the compressed thumbnail image data.

In the embodiment, the data size of the APP1 is fixed to 64 Kbytes. This is because the maximum data size of the APP1 is prescribed to be 64 Kbytes according to the Exif standard. Such maximum size is considered to be a size large enough for the case where the size of compressed thumbnail image data increases more or less.

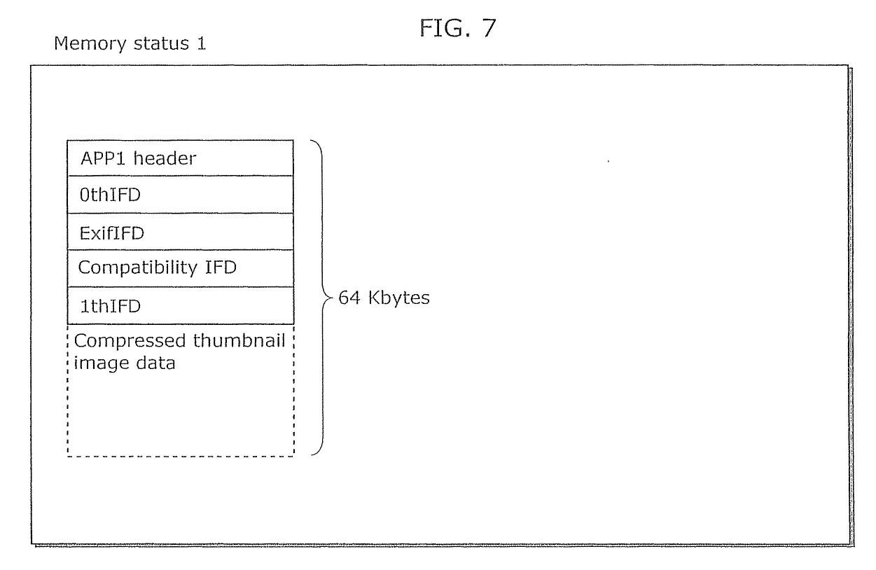

Therefore, the state of the memory 201 before the shooting is as shown in FIG. 7. The microcomputer 211 previously assigns an arbitrary area in the memory 201 to a storage area for APP1, and stores, into the arbitrary storage area, a template of the data included in the APP1, aside from the compressed thumbnail image data. This has a view to quickening the processing by rewriting the part that needs to be rewritten each time an image is shot, since the data in each Exif file, such as a APP1 header, a 0thIFD, an ExifIFD, a compatibility IFD and a 1thIFD, includes many parts that do not need to be changed.

It should be noted that, in the embodiment, it is assumed, in the stage F0, that the power of a digital camera is turned on as a preparation for the shooting.

The following describes the stage F1. In the stage F1, the shutter detection circuit 209 detects a shutter, original image data is stored into the memory 201, and the part, in the APP1 data in the template prepared in the stage F0, which needs to be rewritten is rewritten.

When the user presses a shutter, the shutter detection circuit 209 detects the shutter and outputs a shutter detection trigger to the ASCII conversion unit 210.

Having detected the shutter detection trigger in the shutter detection circuit 209, the ASCII conversion unit 210 reads out time information data from the timer circuit 208, and converts the data into an ASCII code string of “YYY:MM:DD□HH:MM:SS□” (□ means NULL) which is described in an Exif file and requires 20 bytes. Y denotes year and M presents month, while H denotes minute and S represents second.

After the conversion of time information into ASCII codes, the ASCII conversion unit 210 rewrites the part of the time information included in the APP1 stored in the memory 201.

Conventionally, after a microcomputer has stored, into a memory, the time information onto which ASCII conversion is not yet performed, the time information is read out, ASCII conversion is performed onto the information, and the converted time information is again stored into the memory. It is, however, possible to quicken the processing by storing, as needed, the time information on which the ASCII conversion is performed, as is described in the embodiment.

In parallel with the processing described above, the part of the APP1 data previously stored in the stage F0, which needs to be rewritten, shall be rewritten by the microcomputer 211. However, an arbitrary value (e.g. 4 bytes) is written since the size of JPEG compressed thumbnail data to be described in 0thIFD is still not known at this point. The original image data is stored into the memory 201 in the stage F1.

It should be noted that rewriting of ExifIFD, which describes information about shooting conditions such as an exposure time and a shutter speed, is executed in the stage F1, however, such rewriting may be carried out before the stage F3 (to be mentioned later) is terminated.

The following describes the stage F2. In the stage F2, a compression of original image data, a storage of the compressed original image data into the medium 204, and a creation of thumbnail image data are performed in parallel.

Firstly, the creation of a thumbnail image will be described. The ZOOM processing unit 202 reads out original image data from the memory 201, creates a thumbnail image, and writes back the thumbnail image data into the memory 201.

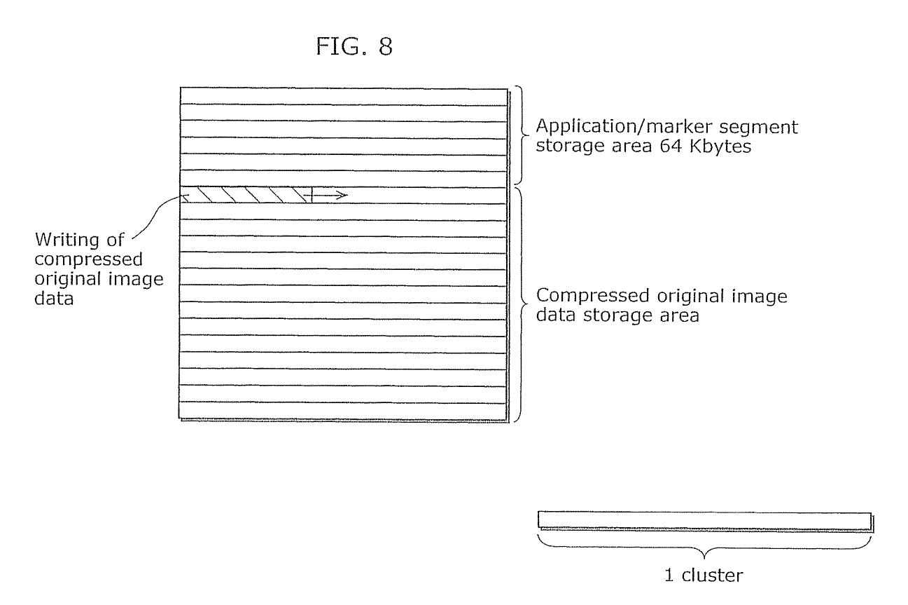

Next, the compression of the original image data and the storage of the compressed original image data into the medium 204 will be described. FIG. 8 shows the operation inside the medium 204 when the compressed original image data is written into the medium 204. In the embodiment, the data size of APP1 is fixed to 64 Kbytes so that it is possible to specify a relative position to start storing the compressed original image data with respect to a position to start storing a compressed data start marker included in each Exif file.

Before the compression of the original image and the storage of the compressed original image data, the microcomputer 211 previously assigns, within the medium 204, an area to store an APP1 and an area to store the compressed original image data. Thus, the microcomputer 211 determines a first address indicating the head of an Exif file and a second address indicating a position obtained by adding a fixed value to the first address. In such case, 64 Kbytes being the size of APP1 data is put into the size indicated by units such as sector and cluster, so that the compressed original image data is written in a location starting from the next sector/cluster following the sector/cluster describing the end of the APP1 data. This solves the problem that an access to a medium applying a FAT system is only possible in units of sectors/clusters. For example, in the case where compressed original image data is stored in the middle of the sector, the occurrence of the operation of reading out the sectors in which the head of the compressed original image data is stored and then writing the APP1 into the read-out sectors is prevented because the storage into the medium can be performed only in units of sectors/clusters when the APP1 is written at the later time.

It should be noted that the APP1 storage area starting from the first address and the compressed original image data storage area starting from the second address are assigned in units of clusters, and the compressed original image data is written starting from the head cluster of the compressed original image data area which begins from the second address.

Such processing should be carried out before each processing is executed. The JPEG compression unit 203 reads out the original image data stored in the memory 201, and performs compression onto the original image data. The compressed original image data is then transmitted, as needed, to the compressed data writing unit 205, and the compressed data writing unit 205 writes the compressed original image data into the previously-assigned area within the medium 204.

Thus, it is possible to shorten the processing time by directly writing into the medium 204 without waiting for the creation of compressed thumbnail image data, the compressed original image data which occupies the most part of the Exif file. This can further shorten the shooting intervals.

The following describes the stage F3.

In the stage F3, the compression is carried out onto the thumbnail image data. The thumbnail image data within the memory 201 is read out by the JPEG image compression unit 203, the compressed thumbnail image data is written into the memory 201 after the JPEG compression. Here, the data is written into the compressed thumbnail image data storage area in the APP1 storage area that is previously assigned within the memory 201 in the stage F0.

The following describes the stage F4. In the stage F4, the APP portion writing unit 207 reads out APP1 data from the memory 201, writes the AFF1 data into the medium 204, and eventually creates an Exif file.

As described above, after the compression of the thumbnail image data, the compressed thumbnail image data is once stored into the memory 201. Here, the EOI detection circuit 206 detects an EOI in a stream of the compressed thumbnail image data, and outputs an EOI detection trigger to the APP portion writing unit 207.

After the EOI detection trigger is inputted, the APP portion writing unit 207 reads out, from the memory 201, the APP1 data which includes the compressed thumbnail image data, and starts writing the APP1 from the head cluster of the previously-assigned APP1 storage area. In this way, after the detection of an EOI, APP1 data is automatically read out from the memory 201, and then stored into the medium 204, so that the processing speed increases.

However, the data size of the compressed thumbnail image data that is described in the 1thIFD in the stage F1 is not correctly written, the size needs to be replaced by the proper size before its storage into the medium 204. The APP portion writing unit 207 is therefore equipped with a function to replace the data size of the compressed thumbnail image data with the size inputted by the JPEG compression unit 203, when a tag (202.h) of the information about the data size of the compressed thumbnail image data is detected while the 1thIFD is being read out from the memory 201.

The following describes the method applied by the APP portion writing unit 207 for replacing the data size of the compressed thumbnail image data with the proper size during the transmission of 1thIFD.

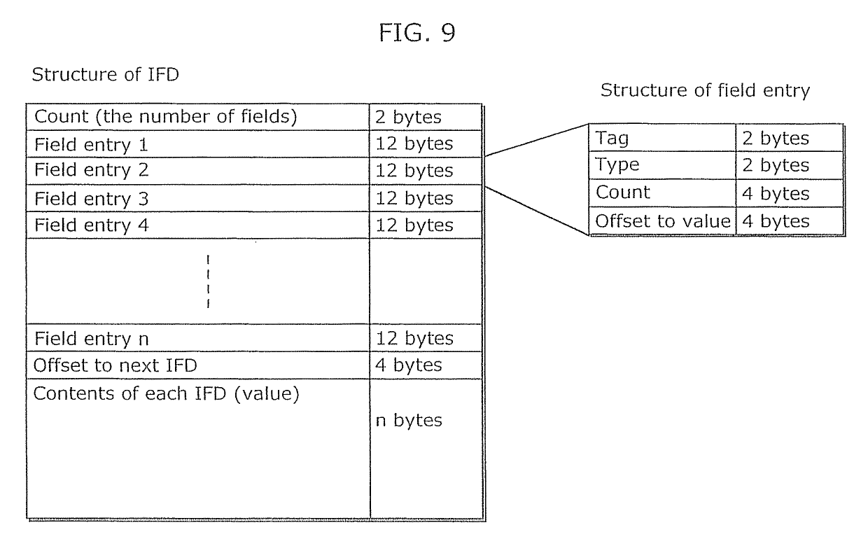

FIG. 9 is a diagram showing a structure of each IFD (0thIFD, ExifIFD, compatibility IFD and 1thIFD). Each IFD is divided into the following items: Field count; N field entries; Offset to the next IFD; and Contents of each field entry value. An offset starting from the head of the Exif file is described in the item “Offset to the next IFD”.

“Field entry” requires 12 bytes and is further divided into items such as “Tag”, “Type”, “Count” and “Offset to value”. Actual information can be described in the item “Offset to value”. In the case where a value to be described requires 4 bytes or less, the actual information is described, but in the case where the actual information requires an amount greater than 4 bytes, the actual information is described into the item “Contents of each field entry value”, therefore, an offset value is described into the item “Offset to value”.

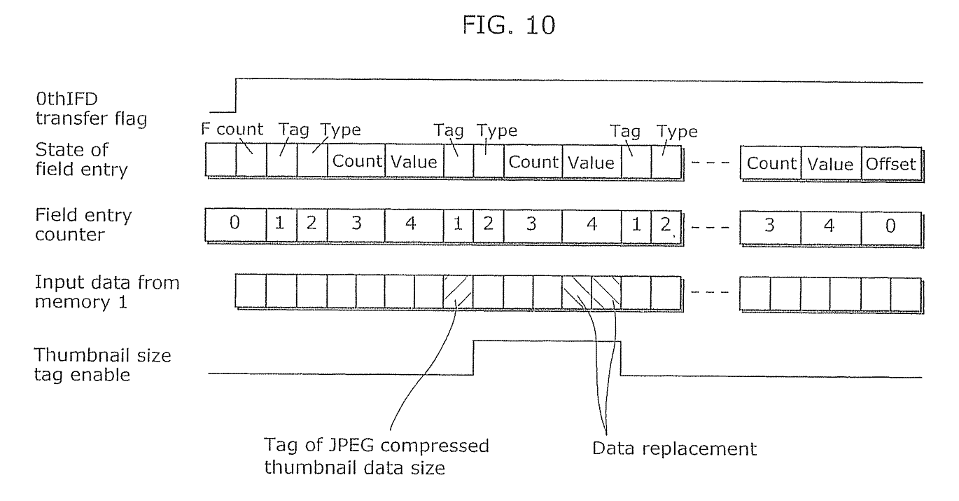

FIG. 10 is a diagram showing a timing for the APP portion writing unit 207 to change the data size of the compressed thumbnail image data. The APP portion writing unit 207 holds information about the data size of each of the data included in the APP1 stored in the memory 201, and is equipped with a counter which counts the amount of data transmitted during the data transfer. The APP portion writing unit 207 therefore can grasp which data of the APP1 is being transmitted by counting the data size and flagging within the unit during the transmission of each of the data included in the APP1.

The concrete method will be described with reference to FIG. 10. The APP portion writing unit 207 flags a transfer flag of the 1thIFD after the transmission of the compatibility IFD being the data immediately prior to the 1thIFD. After reading the number of field entries by reading out the first 2 bytes of “Field count”, the APP portion writing unit 207 resets its own field entry counter, counts up from 1 to 4 for each of the items “Tag”, “Type”, “Count” and “Offset to value”, resets to 1 after reading out 12 bytes, and reads out the next field entry. The same operation continues until the numbers of all the field entries are read out. After the reading-out of all the numbers of the field entries, the value indicated by the counter is reset to 0.

Upon detecting a tag (202.h) of the information indicating the data size of the compressed thumbnail image, when the counter indicates the value 1, the APP portion writing unit 207 properly rewrites, in the field entry, the size of the compressed thumbnail image data. As shown in FIG. 10, the APP portion writing unit 207, in fact, makes a thumbnail size enable signal active, replaces the arbitrary size with the proper size of the compressed thumbnail image data, and negates the thumbnail size enable signal.

It should be noted that the data size information of the compressed thumbnail image can be represented within 4 bytes, therefore, there is no need to consider the case of writing the size of the compressed thumbnail image data into the contents of each IFD that follows the data size information.

Thus, by replacing the size of the compressed thumbnail image data during the transmission of the APP1 data from the memory 201 to the medium 204, the task of microcomputer 211 to rewrite the size of compressed thumbnail image data included in the APP1 data, within the memory 201 can be omitted, before transmission, which leads to the reduction of the processing time.

In the case where the total size of actual APP1 data does not amount to 64 Kbytes which is a possible maximum size, there is a risk that uncertain data aside from the actual data is written into the area previously assigned as an APP1 storage area within the medium 204. In the case where the APP portion writing unit 207 has not transmitted the data equivalent to 64 Kbytes counted back from the start of APP1 transmission, at the time of detecting an EOI marker of the compressed thumbnail image data, namely, in the case where the size of the actual APP1 data does not amount to 64 Kbytes, a fixed value (e.g. 0) shall be written into an area within the APP1 storage area except for the area recording the actual APP1 data that is previously assigned within the medium 204.

As described above, the APP1 including the compressed thumbnail image data is read out from the memory 201 and data equivalent of 64 Kbytes is written into the APP1 storage area previously assigned within the medium 204, so that an Exif file is created.

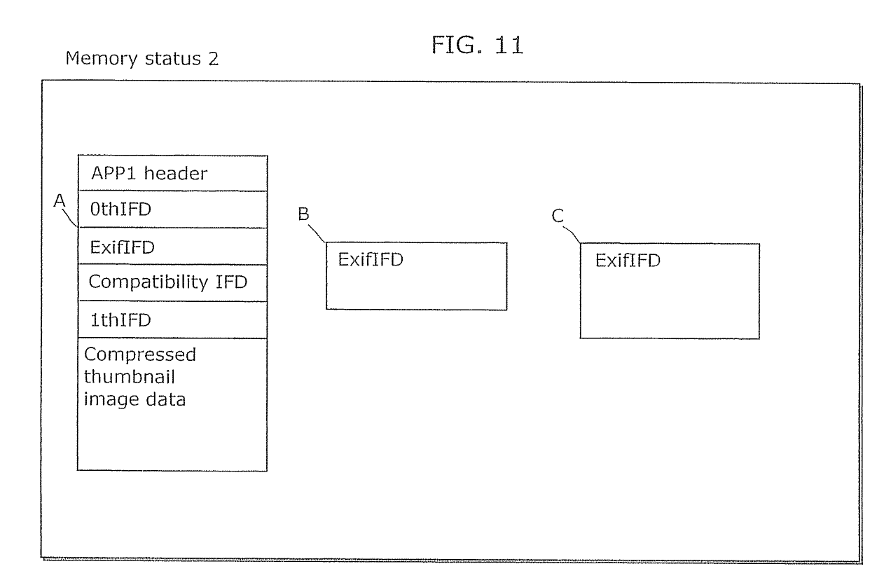

It is further possible to efficiently use a memory by adding, to the APP portion writing unit 207, a function to read out each data in the APP1 within the memory 201, and set a start address, This function is effective for changing the information amount of each IFD. For example, three modes are provided as shooting modes, and in the case where the amount of information described in the Exif file differs according to the mode, a storage area shall be normally allocated for all the APP1 data within the memory 201 for each mode. However, with the APP portion writing unit 207 capable of setting, for each data, a start address for reading out the APP1 data stored in the memory 201, a storage area shall be provided for the ExifIFDs with different information amounts as shown in FIG. 11. In this case, a storage area is assigned as shown in FIG. 11, a template is prepared for each data excepting the compressed thumbnail image data, and an address A is read in the case of mode 1, an address B in the case of mode 2, and ExifIFD data from an address C in the case of mode 3.

By executing each processing in such order as described in detail above, it is possible to shorten the time required from shooting until the end of writing into a medium, and thereby to greatly shorten the shooting intervals. With the timing as shown in FIG. 5B, the processing time can be further reduced.

The method shown in FIG. 5B is used by the compressed data writing unit 205 to directly write both compressed thumbnail image data and compressed original image data into the medium 204, without writing them into the memory 201. This necessitates the previous allocation of the compressed thumbnail image data storage areas within the medium 204.

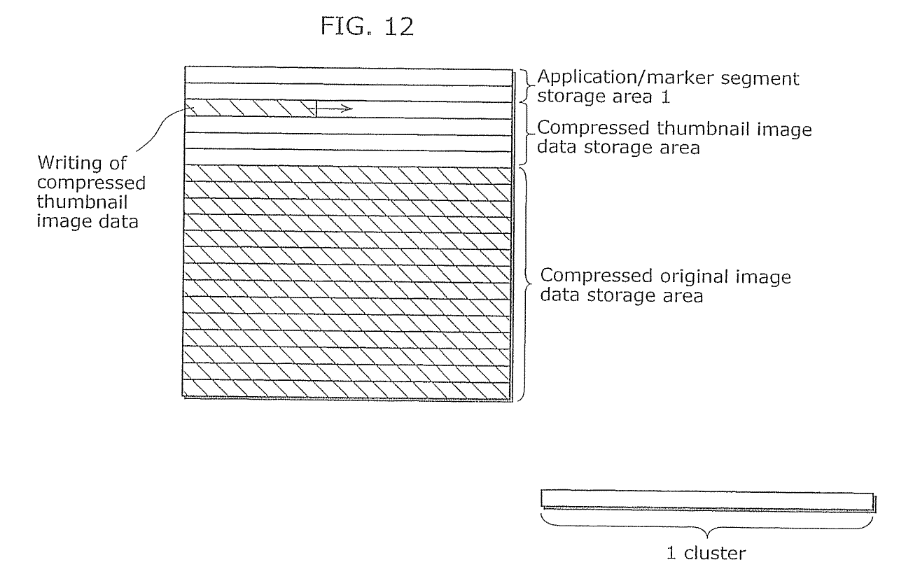

FIG. 12 shows the operation inside the medium 204 in the case where the compressed thumbnail image data is directly written into the medium 204, without going through the memory 201. In the stage F3, a total size of the APP1 header aside from the compressed thumbnail image data of the APP1 (includes a compressed data start marker), 0thIFD, ExifIFD, compatibility IFD and 1thIFD is fixed using a unit of cluster, and is previously assigned as an APP1 storage area 1. A compressed thumbnail image data storage area for recording compressed thumbnail image data is also assigned beforehand. The compressed data writing unit 205 writes the compressed thumbnail image data outputted from the JPEG compression unit 203 into the compressed thumbnail image data storage area within the medium 204.

After that, in the stage F4, the APP1 header (including a compressed data start marker), 0thIFD, ExifIFD, compatibility IFD and 1thIFD are written into the APP1 storage area 1. With this, it is possible to shorten the time required for storing once the compressed thumbnail image data into the memory 201 as well as the time required for the APP portion writing unit 207 to transmit the compressed thumbnail image data.

It should be noted that a start position of each Exif file in a medium shall be designated to be the head address of the storable area in the medium.

The embodiment is described using an image file complying with the Exif and compressed image data complying with the JPEG, however, they may comply with a different standard.

Non-compressed image data instead of compressed original image data may be used.

In the embodiment, it is described that the size of actual APP information is smaller than a fixed size (64 Kbytes in the embodiment). That is to say that 0 or 1 is inserted into an area starting from the end of the actual APP1 information until the position to start storing the compressed original image data. Instead of inserting 0 or 1 into the area, data with meaning may be inserted. For example, arbitrary data such as user's memo, audio data, data that does not relate to image may be inserted.

The external memory 108 is an external recording medium. As such, a removable SD card (R) or memory stick (R) is generally used, but a built-in storage may be used instead.

A1though only some exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

An apparatus and a method of the present invention, for storing an image file into a memory, are each suitable for an apparatus which stores an image shot by a camera such as a camera equipped in a digital steel camera, a digital movie, a cell phone, and a camera incorporated into an information processing apparatus.

1. An image file recording apparatus which records, into a recording medium, an image file including image data and header information which has variable-length information, said apparatus comprising:
a generation unit operable to generate image data;
a determination unit operable to determine a first address indicating a head of the image file, and a second address obtained by adding a fixed value to the first address; and
a writing unit operable to write, without going through a memory, the image data into an area, in the recording medium, starting from the second address.

2. The image file recording apparatus according to claim 1,
wherein said determination unit is operable to determine, as the first address, a head address of a free space in the recording medium.

3. The image file recording apparatus according to claim 1,
wherein said writing unit is operable to write the image data into the recording medium in parallel with the generation of image data performed by said generation unit.

4. The image file recording apparatus according to claim 2,
wherein after generating the image data, said generation unit is further operable to generate thumbnail image data of the image data, and
said writing unit is further operable to record header information including the thumbnail image data into an area between the first address and the second address in the recording medium.

5. The image file recording apparatus according to the claim 4,
wherein said writing unit is operable to write the thumbnail image data into the recording medium in parallel with the generation of thumbnail image data performed by said generation unit.

6. The image file recording apparatus according to claim 4, further comprising
a detection unit operable to detect an end-of-image code indicating an end of the image data generated by said generation unit,
wherein said writing unit is operable to start recording the header information when an end-of-image code is detected by said detection unit.

7. The image file recording apparatus according to claim 4, further comprising
a creation unit operable to create header information which excludes thumbnail information related to the thumbnail image data, before the thumbnail image data is generated by said generation unit, and to record the created header information into the recording medium,
wherein said writing unit is operable to obtain, from said generation unit, the thumbnail information before the thumbnail image data is generated by said generation unit, and to write, as the header information, the created header information stored in the memory and the obtained thumbnail information into the recording medium.

8. The image file recording apparatus according to claim 4, further comprising
a conversion unit operable to convert, into a text, a time signal outputted from a timer circuit,
wherein said creation unit is operable to obtain, from said conversion unit, the text as a part of the header information.

9. A camera comprising the image file recording apparatus according to claim 1.

10. An image file recording method for recording, into a recording medium, an image file including image data and header information which has variable-length information, said method comprising:
generating image data;
determining a first address indicating a head of the image file, and a second address obtained by adding a fixed value to the first address; and
writing the image data into an area, in the recording medium, starting from the second address, without going through a memory.

11. The image file recording method according to claim 10,
wherein, in said determining, a head address of a free space in the recording medium is determined as the first address.

12. The image file recording method according to claim 10,
wherein, in said writing, the image data is written into the recording medium in parallel with the generation of image data performed in said generating.

13. The image file recording method according to claim 10,
wherein said generating further includes generating thumbnail image data of the image data after the image data is generated, and
said writing further includes recording header information which includes the thumbnail image data, into an area between the first address and the second address in the recording medium.

14. The image file recording method according to claim 13,
wherein, in said writing, the thumbnail image data is written into the recording medium in parallel with the generation of thumbnail image data performed in said generating.

15. The image file recording method according to claim 14, further comprising
detecting an end-of-image code, using a circuit for detecting an end-of-image code, the end-of-image code indicating an end of the image data generated in said generating,
wherein the recording of header information performed in said writing starts, when an end-of-image code is detected in said detecting.

16. The image file recording method according to claim 13, further comprising
creating header information except for thumbnail information related to the thumbnail image data, and storing the created header information into a memory,
wherein, in said writing, the thumbnail information is obtained after the creation of the thumbnail image data, and the created header information stored in the memory and the obtained thumbnail information are written into the recording medium, as the header information.

17. The image file recording method according to claim 13, further comprising
converting a time signal into a text, using a conversion circuit for converting a time signal outputted from a timer into a text,
wherein, in said creating, the text is obtained as a part of the header information.

18. An image file recording method for recording, into a recording medium, an image file including image data and header information which has variable-length information, said method comprising:
generating image data;
creating header information with a fixed data size; and
writing the header information and the image data into the recording medium so that an end position of the header information is followed by a start position of the image data.
